(19) United States
(12) Patent Application Publication
(10) Pub. No.: US 2014/0176032 A1
(43) Pub. Date: Jun. 26, 2014

(54) BACK ELECTROMOTIVE FORCE DETECTION CIRCUIT, AND MOTOR DRIVING CONTROL APPARATUS AND MOTOR USING THE SAME

(71) Applicant: SAMSUNG ELECTRO-MECHANICS CO., LTD, Suwon (KR)

(72) Inventor: Soo Woong LEE, Suwon (KR)

(73) Assignee: SAMSUNG ELECTRO-MECHANICS CO., LTD., Suwon (KR)

(21) Appl. No.: 13/793,970

(22) Filed: Mar. 11, 2013

(30) Foreign Application Priority Data
Dec. 21, 2012 (KR) 10-2012-0151469

(51) Int. Cl. H02P 6/18

(52) U.S. Cl. CPC H02P 6/182
USPC 318/400.35

(57) ABSTRACT

There are provided a back electromotive force detection circuit, and a motor driving control apparatus and a motor using the same. The back electromotive force detection circuit includes: a voltage generating unit generating a voltage in inverse proportion to a duty ratio of a pulse width modulation (PWM) signal; a variable amplifier controlling a gain according to the voltage generated by the voltage generating unit, and amplifying back electromotive force according to the controlled gain; and a comparator comparing an output from the variable amplifier with a pre-set reference signal, and outputting a zero-crossing signal of the back electromotive force.

### CROSS-REFERENCE TO RELATED APPLICATIONS

This application claims the priority of Korean Patent Application No. 10-2012-0151469 filed on Dec. 21, 2012, in the Korean Intellectual Property Office, the disclosure of which is incorporated herein by reference.

### BACKGROUND OF THE INVENTION

1. Field of the Invention

The present invention relates to a back electromotive force detection circuit, and a motor driving control apparatus and a motor using the same.

2. Description of the Related Art

In line with the development of motor technologies, motors having various sizes have been used in diverse technical fields.

In general, a motor is driven by rotating a rotor by using a permanent magnet and a coil having polarity changing according to a current applied thereto. Initially, a brush type motor having a coil in a rotor was provided, which, however, had a problem in that a brush thereof was abraded or sparks could be generated.

Thus, recently, various types of brushless motor have been used globally. A brushless motor, eliminating mechanical contact units such as a brush, a rectifier, or the like, is a DC motor driven by using an electronic commutating mechanism instead. The brushless motor may include a stator configured as a permanent magnet and a rotor having coils corresponding to a plurality of phases and rotating by magnetic force generated by phase voltages of the respective coils.

In order to effectively drive a brushless motor, commutation of each phase (coil) of a rotor should be made at an appropriate timing, and for appropriate commutation, a position of a rotor is required to be recognized.

In order to determine a position of a rotor, in the related art, an element such as a hall sensor, a resolver, or the like, is used, but, in this case, a driving circuit may be relatively complicated.

In order to complement this, a technique of driving a brushless motor by recognizing a position of a phase by using back electromotive force (BEMF), replacing a sensor, has been widely used.

However, back electromotive force has the characteristic of being proportional to a rotational speed of a motor, so if a rotational speed of a motor is low, only a very small amount of back electromotive voltage may be detected or no back electromotive voltage may be detected, making it difficult to perform an accurate operation. Meanwhile, when a rotational speed of a motor is high, a large amount of back electromotive force is detected, putting a burden on the circuit.

Namely, due to the characteristics of back electromotive force proportional to a rotational speed of a motor, an extensive voltage range of back electromotive force is detected, so it is difficult to accurately drive a motor.

The related art document below relates to a motor technology, which, however, does not provide a solution to the foregoing problems.

### RELATED ART DOCUMENT

(Patent document 1) Korean Patent Laid Open Publication No. 2005-0012745

### SUMMARY OF THE INVENTION

An aspect of the present invention provides a motor driving control apparatus allowing for accurately controlling motor driving by amplifying back electromotive force with a gain in inverse proportion to a rotational speed of the motor to thus detect back electromotive force amplified to fall within a predetermined range regardless of the rotational speed of the motor, a motor driving control method, and a motor using the same.

According to an aspect of the present invention, there is provided a back electromotive force detection circuit including: a voltage generating unit generating a voltage in inverse proportion to a duty ratio of a pulse width modulation (PWM) signal; a variable amplifier controlling a gain according to the voltage generated by the voltage generating unit, and amplifying back electromotive force according to the controlled gain; and a comparator comparing an output from the variable amplifier with a pre-set reference signal, and outputting a zero-crossing signal of the back electromotive force.

The voltage generating unit may include: a duty calculator calculating a duty ratio of the PWM signal; and a DC voltage generator generating a DC voltage in inverse proportion to the duty ratio calculated by the duty calculator.

The duty calculator may include: a clock generator generating clocks having a frequency higher than that of the PWM signal; and wherein the duty calculator calculates a duty ratio of the PWM signal by using an amount of the clocks in which the PWM signal has a high value during a predetermined period of time.

The DC voltage generator may include a plurality of resistors connected in series to an input voltage; and a plurality of switches connected to one end of any one of the plurality of resistors in parallel.

When the plurality of switches are switched on, the plurality of switches output different voltage values, and the duty calculator may turn on any one of the plurality of switches to gain a voltage in inverse proportion to the duty ratio of the PWM signal.

According to another aspect of the present invention, there is provided a motor driving control apparatus. The motor driving control apparatus may include: a driving signal generating unit generating a pulse width modulation (PWM) signal for controlling driving of a motor device; a back electromotive force detection unit detecting a zero-crossing point of back electromotive force of the motor device, independently from a change in a rotational speed of the motor device; and a controller determining a phase conversion time of the motor device according to the zero-crossing point, and controlling the driving signal generating unit to adjust the PWM signal.

The rotational speed of the motor device may be proportional to a duty ratio of the PWM signal, and the back electromotive force detection unit may amplify the back electromotive force with a gain in inverse proportion to the duty ratio of the PWM signal, and detect the zero-crossing point by using back electromotive force having a predetermined range value independently from a change in the rotational speed of the motor device.

The back electromotive force detection unit may include: a back electromotive force amplifying unit amplifying the back electromotive force with a gain in inverse proportion to the duty ratio of the PWM signal; and a comparator comparing the back electromotive force amplified by the back electromotive force amplifying unit with a pre-set reference signal, and outputting a zero-crossing signal of the back electromotive force.

The back electromotive force amplifying unit may include: a voltage generating unit generating a voltage in inverse proportion to the duty ratio of the PWM signal; and a variable amplifier controlling a gain according to a voltage generated by the voltage generating unit and amplifying the back electromotive force according to the controlled gain.

The voltage generating unit may include: a clock generator generating clocks having a frequency higher than that of the PWM signal; a duty calculator calculating a duty ratio of the PWM signal by using an amount of the clocks in which the PWM signal has a high value during a predetermined period of time; and a DC voltage generator generating a DC voltage in inverse proportion to the duty ratio calculated by the duty calculator.

The DC voltage generator may include: a plurality of resistors connected in series to an input voltage; and a plurality of switches connected to one end of any one of the plurality of resistors in parallel and outputting different voltage values in the event of ON switching, wherein the duty calculator may turn on any one of the plurality of switches to gain a voltage in inverse proportion to the duty ratio of the PWM signal.

According to another aspect of the present invention, there is provided a motor. The motor may include: a motor device rotating according to a pulse width modulation (PWM) signal; and a motor driving control apparatus determining a phase conversion time of the motor device by detecting a zero-crossing point of back electromotive force of the motor device independently from a change in a rotational speed of the motor device, and controlling driving of the motor device by providing the PWM signal reflecting the phase conversion time to the motor device.

The motor driving control apparatus may include: a driving signal generating unit generating a PWM signal for controlling driving of the motor device; a back electromotive force detection unit detecting a zero-crossing point of back electromotive force of the motor device, independently from a change in a rotational speed of the motor device; and a controller determining a phase conversion time of the motor device according to the zero-crossing time, and controlling the driving signal generating unit to adjust the PWM signal.

The back electromotive force detection unit may include: a voltage generating unit generating a voltage in inverse proportion to a duty ratio of the PWM signal; a variable amplifier controlling a gain according to the voltage generated by the voltage generating unit and amplifying back electromotive force according to the controlled gain; and a comparator comparing an output from the variable amplifier with a pre-set reference signal and outputting a zero-crossing signal of the back electromotive force.

The voltage generating unit may include: a clock generator generating clocks having a frequency higher than that of the PWM signal; a duty calculator calculating a duty ratio of the PWM signal by using an amount of the clocks in which the PWM signal has a high value during a predetermined period of time; and a DC voltage generator generating a DC voltage in inverse proportion to the duty ratio calculated by the duty calculator.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a motor driving control apparatus according to an embodiment of the present invention;

FIG. 2 is a schematic circuit diagram illustrating an example of an inverter unit and a back electromotive force detection unit;

FIG. 3 is a schematic view illustrating a configuration of the back electromotive force detection unit according to an embodiment of the present invention;

FIG. 4 is a schematic view illustrating a configuration of an example of a duty calculator of FIG. 3;

FIG. 5 is a schematic view illustrating a configuration of a DC voltage generator of FIG. 3;

FIG. 6 is a reference graph showing a relationship between a speed of a motor device and back electromotive force; and

FIG. 7 is a reference graph showing a duty ration between a gain of a variable amplifier and a pulse width modulation (PWM) signal according to an embodiment of the present invention.

### DETAILED DESCRIPTION OF THE PREFERRED EMBODIMENT

Embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like components.

Hereinafter, embodiments of the present invention will be described based on a brushless motor for the purposes of description. However, obviously, the scope of the present invention is not necessarily limited to the brushless motor.

Also, hereinafter, a motor itself will be referred to as a motor device 160, and a motor driving control apparatus 100 for controlling driving of the motor device, and the motor device 160 will be generally referred to as a motor.

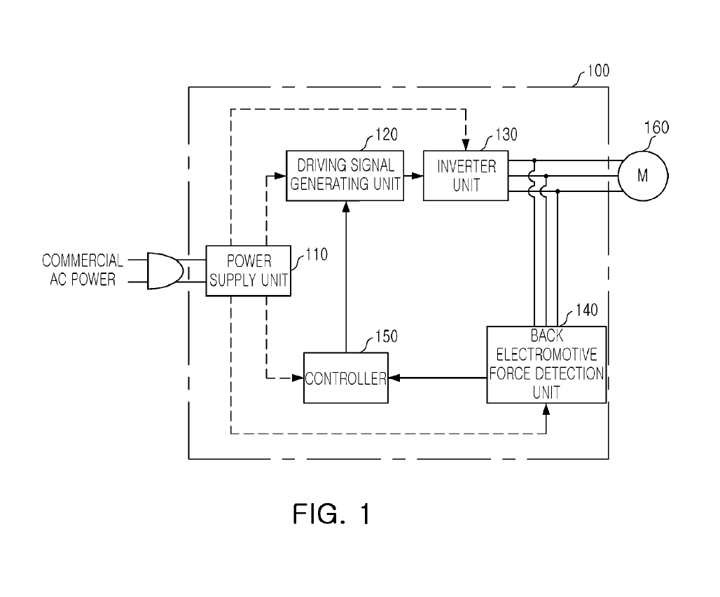

FIG. 1 is a block diagram of a motor driving control apparatus according to an embodiment of the present invention.

The motor device 160 may perform a rotational operation according to a pulse width modulation (PWM) signal. For example, magnetic fields may be generated in respective coils of the motor device 160 by a driving current provided from the inverter unit 130. A rotor provided in the motor device 160 may be rotated by magnetic fields generated in the coils.

The motor driving control apparatus 100 may control driving of the motor device 160 by providing a PWM signal to the motor device 100.

The motor driving control apparatus 100, independent from a change in a rotational speed of the motor device 160, may detect a zero-crossing point of back electromotive force of the motor device 160 to determine a phase conversion time (or a phase commutation time) of the motor device 160. Also, the motor driving control apparatus 100 may control driving of the motor device 160 by providing a PWM signal reflecting the phase conversion time to the motor device 160.

The motor driving control apparatus 100 may include a power supply unit 110, a driving signal generating unit 120, an inverter unit 130, a back electromotive force detection unit 140, and a controller 150.

The power supply unit 110 may supply power to the respective elements of the motor driving control apparatus 100. For example, the power supply unit 110 may convert an AC voltage of commercial power into a direct current (DC) voltage and supply the same. In the illustrated example, the dotted lines indicate predetermined power supplied from the power supply unit 110.

The driving signal generating unit 120 may provide a pulse width modulation (PWM) signal to the inverter unit 130.

In an embodiment, the driving signal generating unit 120 may adjust a frequency of the PWM signal by applying a variable DC level to a predetermined reference waveform (e.g., a triangular wave).

The inverter unit 130 may enable the motor device 160 to operate. For example, the inverter unit 130 may convert a DC voltage into a multi-phase (e.g., 3-phase to 4-phase) voltage according to a PWM signal and apply the same to coils (corresponding to the plurality of phases) of the motor device 160 to produce magnetic fields, respectively.

In an embodiment, the inverter unit 130 may enable the rotor of the motor device 160 to rotate by sequentially applying phase voltages to a plurality of phases. For example, on the assumption that a stator of the motor device 160 is a permanent magnet having polarity and a rotor has three coils, the inverter unit 130 may sequentially apply phase voltages to the three coils (three phases) to generate magnetic fields. Thus, due to the generated magnetic fields, the rotor may have a predetermined polarity as well as sequential polarities for each phase, whereby the rotor rotates about the stator (by being centered thereon).

The back electromotive force detection unit 140 may detect back electromotive force generated by the motor device 160. In detail, when the motor device 160 is rotated, back electromotive force is generated in a coil to which a phase voltage has not been applied, among coils provided in the rotor, due to induced electromotive force. Thus, in this manner, the back electromotive force detection unit 140 may detect back electromotive force generated by the respective coils of the motor device 160.

The back electromotive force detection unit 140 may detect a zero-crossing point of back electromotive force of the motor device 160, independently from a change in a rotational speed of the motor device 160.

In an embodiment of the present invention, the back electromotive force detection unit 140 may amplify back electromotive force with a gain in inverse proportion to a duty ratio of the PWM signal to detect a zero-crossing point by using back electromotive force having a predetermined range value independently from a change in a rotational speed of the motor device 160.

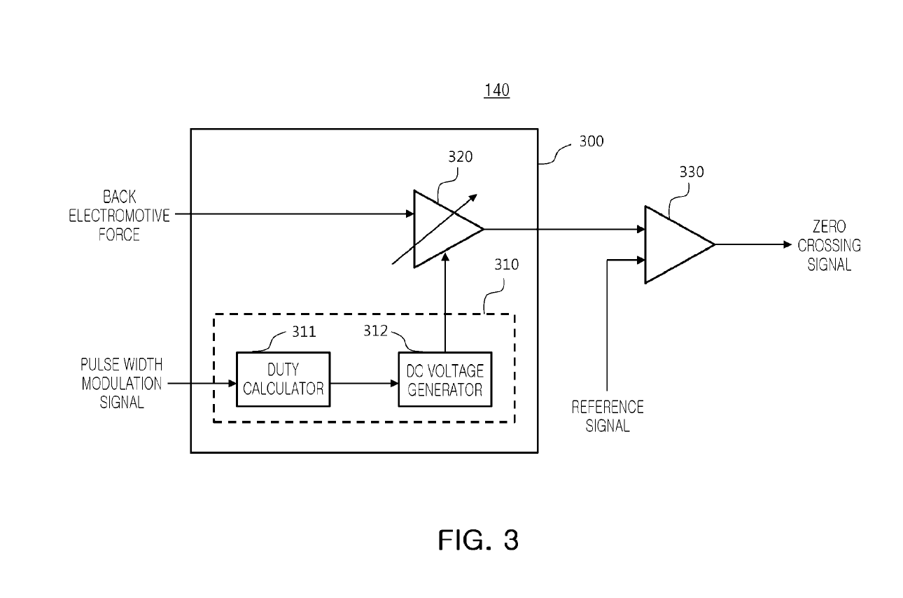

The back electromotive force detection unit 140 will be described in detail with reference to FIGS. 3 through 5, hereinbelow.

The controller 150 may check a phase change timing of the motor device 160 and control the driving signal generating unit 120 to generate a driving control signal by using the checked phase change timing. For example, the controller 150 may control the driving signal generating unit 120 to perform a phase change at a zero-crossing timing of back electromotive force.

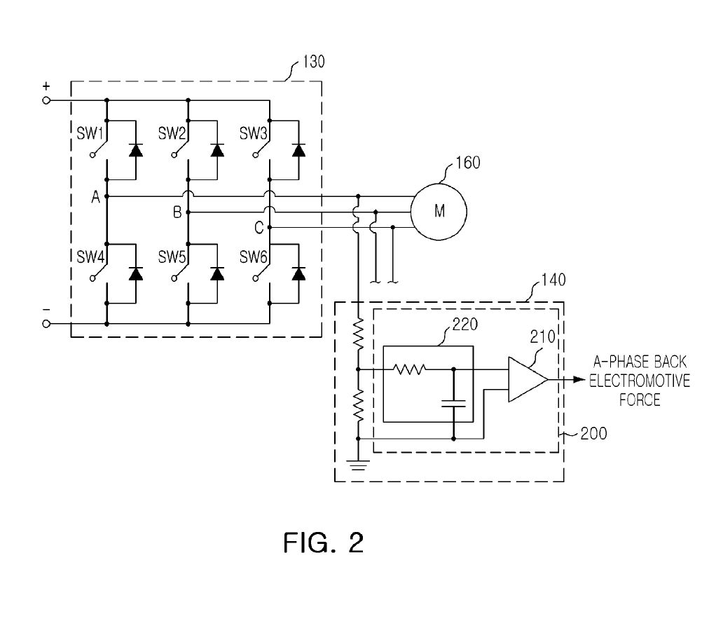

FIG. 2 is a schematic circuit diagram illustrating an example of the inverter unit and the back electromotive force detection unit.

Referring to FIG. 2, the inverter unit 130 may include a plurality of higher switch elements SW1 to SW3 connected to a positive (+) power source terminal and a plurality of lower switch elements SW4 to SW6 provided between the respective higher switch elements SW1 to SW3 and a power source terminal. Contacts between the respective higher switch elements SW1 to SW3 and the lower switch elements SW4 to SW6 are connected to respective coils U, V, W.

The higher switch elements SW1 to SW3 of the inverter unit 130 are sequentially turned on, and the lower switch elements SW4 to SW6 are turned on or off to have a state opposite to that of the higher switch elements SW1 to SW3 Here, when the switch element SW1 is turned on, a positive (+) voltage is applied to the U coil of the motor device 160, and as the switch element SW6 is turned on during the operation, a negative (−) voltage is applied to the W coil. Accordingly, magnetic forces having the opposite polarities are generated between the U coil and the W coil and a rotor is rotated by 60 degrees according to the interaction between the magnetic forces. Subsequently, as the switch element SW1 is turned off and the switch element SW2 is turned on, magnetic force having polarity opposite the magnetic force generated by the W coil is generated by the V coil, and according to this magnetic force, the motor device 160 is rotated further by 60 degrees. Similarly, while the switch element SW2 is in an ON state, the switch SW6 is turned off and the switch element SW4 is turned on, magnetic force having polarity opposite to that of the magnetic force of the V coil is generated by the U coil, and the rotor is further rotated by 60 degrees. Next, as the switch element SW2 is turned off, the switch element SW3 is turned on, magnetic forces having opposite polarities are generated by the U coil and the W coil, the motor device 160 is further rotated by 60 degrees, the switching element SW4 is subsequently turned off and the switch element SW5 is turned on, and thus, the rotor is rotated by 60 degrees by the magnetic forces of the U coil and the V coil.

As this process is repeatedly performed, the rotor is continuously rotated to operate the motor device 160.

As described above, when the motor device 160 rotates, back electromotive force is generated in a coil to which a phase voltage has not been applied among the respective coils U, V, and W, and the back electromotive force detection unit 140 may detect the back electromotive force.

The back electromotive force detection unit 140 may include a plurality of back electromotive force detection circuits 200 connected to a plurality of phases of the motor device 160, respectively. In the illustrated example, the motor device 160 has 3 phases, so the back electromotive force detection unit 140 may include three back electromotive force detection circuits 200.

The back electromotive force detection circuit 200 may include a comparator 210 and a filter unit 220.

The low pass filter 220 may filter a voltage of any one of the plurality of phases, and the comparator 210 may detect back electromotive force upon receiving an output from the filter unit 220 as a non-inverting input and a reference voltage as an inverting input. For example, the filter unit 220 may be a low pass filter, and in this case, the filter unit 220 may include a resistor and a capacitor connected in parallel.

For example, the back electromotive force detection circuit 200 illustrated in FIG. 2 uses back electromotive force generated by the motor device 160 as is without amplifying it. However, in this case, back electromotive force may not be detected or an excessive current may be detected according to a size of a speed of the motor device 160.

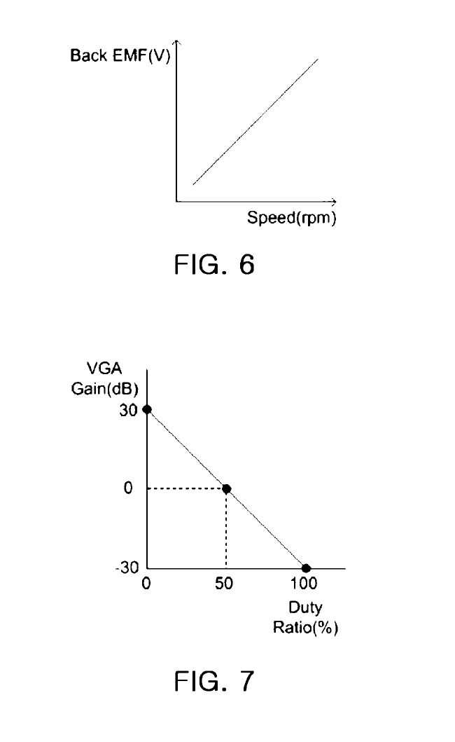

This will be described in detail with reference to the graph of FIG. 6. The back electromotive force (back EMF) is a voltage detected from the motor device 160, and it can be seen that the voltage is proportional to the speed of the motor device 160.

Thus, when the motor device 160 does not rotate or rotation thereof is low in speed, a very small amount of back electromotive voltage may be detected or no back electromotive voltage may be detected, making it difficult to perform an accurate operation. Meanwhile, when a rotational speed of a motor is high, a large back electromotive force is detected, laying a burden on the motor driving control apparatus 100.

Thus, in an embodiment of the present invention, a zero-crossing point of back electromotive force is checked by amplifying back electromotive force, and in this case, the back electromotive force is amplified with a gain in inverse proportion to the speed of the motor device 160 to check the zero-crossing point by using amplified back electromotive force having a predetermined range irrespective of a magnitude of the back electromotive force.

Hereinafter, the back electromotive force detection unit 140 will be described in detail with reference to FIGS. 3 through 5. Hereinafter, the back electromotive force detection unit 140 is used as being in apposition to the back electromotive force detection circuit, but actually, the back electromotive force detection unit 140 is a function configuration including the back electromotive force detection circuit.

The back electromotive force detection unit 140 amplifies back electromotive force with a gain in inverse proportion to a duty ratio of a PWM signal and detects the zero-crossing point by using the back electromotive force having a predetermined value independently from a change in a rotational speed of the motor device 160.

FIG. 3 is a schematic view illustrating a configuration of the back electromotive force detection unit according to an embodiment of the present invention.

Referring to FIG. 3, the back electromotive force detection unit 140 may include a back electromotive force amplifying unit 300 and a comparator 330.

The back electromotive force may amplify back electromotive force with a gain in inverse proportion to a duty ratio of a PWM signal.

In an embodiment of the present invention, the back electromotive force amplifying unit 300 may include a voltage generating unit 310 and a variable amplifier 320.

The voltage generating unit 310 may receive a PWM signal, generate a voltage in inverse proportion to a duty ratio of the PWM signal, and output the same.

In an embodiment of the present invention, the voltage generating unit 310 may include a duty calculator 311 and a DC voltage generator 312.

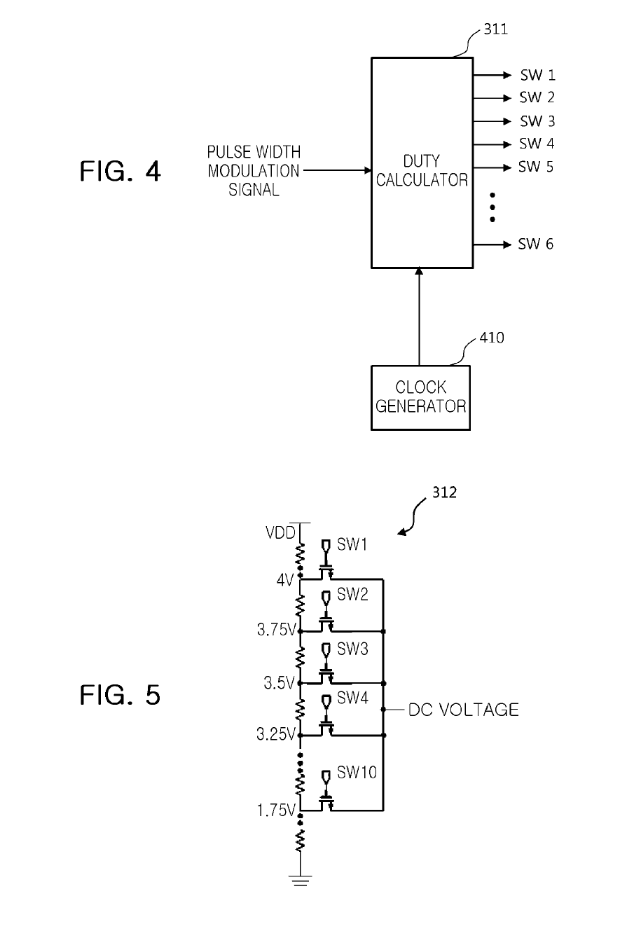

The duty calculator 311 may receive the PWM signal and calculate a duty ratio of the received PWM signal. The duty calculator 311 will be described in detail with reference to FIG. 4 hereinbelow.

The DC voltage generator 312 may generate a DC voltage in inverse proportion to the duty ratio calculated by the duty calculator 311, and provide the generated DC voltage to the variable amplifier 320. Namely, the DC voltage generated by the DC voltage generator 312 may be a signal for controlling a gain of the variable amplifier 320.

The variable amplifier 320 may control gain thereof according to a voltage generated by the voltage generating unit 310, and amplify back electromotive force according to the controlled gain thereof.

The comparator 330 may compare the back electromotive force amplified by the back electromotive force amplifying unit 300 with a pre-set reference signal, and output a zero-crossing signal of the back electromotive force.

FIG. 4 is a schematic view illustrating a configuration of an example of the duty calculator of FIG. 3, and FIG. 5 is a schematic view illustrating a configuration of the DC voltage generator of FIG. 3.

Hereinafter, the duty calculator and the DC voltage generator will be described in detail with reference to FIGS. 4 and 5.

The duty calculator 311 illustrated in FIG. 4 may receive a PWM signal and a clock signal provided from a clock generator 410, and detect a duty ratio of the PWM signal.

In detail, the clock generator 410 may generate clocks having a frequency higher than that of the PWM signal. The duty calculator 311 may calculate a duty ratio of the PWM signal by counting an amount of clocks in which a PWM signal has a high value during a predetermined period of time (a unit time).

For example, in the case that the clock generator 410 generates a clock having a frequency 1000 fold greater than that of the PWM signal and the duty calculator 311 sets 100,000 clocks as a unit time. If high values of the PWM signals detected during the 100,000 clocks are 10,000 values, the duty calculator 311 may determine the duty ratio of the corresponding PWM signal, as 10%. Alternatively, when high values of the PWM signals detected by the duty calculator 311 are 65,000 values, the duty calculator 311 may determine the duty ratio of the corresponding PWM signal, as 65%.

In an embodiment of the present invention, the duty calculator 311 may classify the detected duty ratio by a predetermined range, and output the same. For example, the duty calculator 311 may classify the duty ratios by 10 units, generate switching control signals corresponding to the classified duty ratios, and output the same. Table 1 below shows the classification of duty ratios and switching control signals.

TABLE 1

| No | Duty ratio | Switching control signal |
|---|---|---|
| 1 | ~10% | SW1 |
| 2 | ~20% | SW2 |
| 3 | ~30% | SW3 |
| 4 | ~40% | SW4 |
| 5 | ~50% | SW5 |
| 6 | ~60% | SW6 |
| 7 | ~70% | SW7 |
| 8 | ~80% | SW8 |
| 9 | ~90% | SW9 |
| 10 | ~100% | SW10 |

Here, the switching control signals output from the duty calculator 311 may be provided as an input of the DC voltage generator 312, e.g., as inputs to a plurality of switches SW1 to SW10 included in the DC voltage generator 312.

The DC voltage generator 312 illustrated in FIG. 5 may include a plurality of resistors connected in series to an input voltage and a plurality of switches SW1 to SW10 connected to one end of any one of the plurality of resistors in parallel. Here, the plurality of switches SW1 to SW10 may output different voltage values in the event of ON switching.

Also, as illustrated, as the number of the switches is smaller, a higher DC voltage may be output. Namely, it can be seen that, since the input voltage VDD has a fixed value and a voltage drop occurs by the respective resistor elements, the respective switches may connect differential DC voltages to an output terminal in the event of ON operation, respectively.

Referring to the example illustrated in FIGS. 4 and 5, when a duty ratio calculated by the duty calculator 311 is 35%, the duty calculator 311 sets a signal of the switch SW4, as ON, and provides the same to the DC voltage generator 312. Thus, when the switch SW4 of the DC voltage generator 312 is turned on, the DC voltage generator 312 outputs a current associated with the switch SW4, i.e., 3.25V in the illustrated example, as a DC voltage.

Thus, when a duty ratio of the PWM signal calculated by the duty calculator 311 is low, the DC voltage generator 312 outputs a high DC voltage, and when a duty ratio of the PWM signal calculated by the duty calculator 311 is high, the DC voltage generator 312 outputs a low DC voltage.

Also, it can be seen that the DC voltage generator 312 provides a generated DC voltage as an input of the variable amplifier 320. Thus, as a result, if a duty ratio of the PWM signal is low, the variable amplifier 320 may amplify back electromotive force with a high gain, and if a duty ratio of the PWM signal is high, the variable amplifier 320 may amplify back electromotive force with a low gain. This may be schematized in the graph of FIG. 7.

Referring back to FIG. 3, the variable amplifier 320 amplifies back electromotive force with a gain in inverse proportion to the duty ratio of the PWM signal.

Also, since the back electromotive force is proportional to the duty ratio of the PWM signal, resultantly, the variable amplifier 320 amplifies the back electromotive force with a gain in inverse proportion to the magnitude of the back electromotive force. Namely, when the back electromotive force is large, the variable amplifier 320 amplifies the back electromotive force with a low gain, and when the back electromotive force is low, the variable amplifier 320 amplifies the back electromotive force with a large gain, and thus, it can be seen that the amplified back electromotive force falls within a predetermined range.

Thus, since the comparator 330 generates a zero-crossing signal by using the amplified back electromotive force that falls within the predetermined range, it can calculate an accurate zero-crossing point irrespective of a rotational speed of the motor device 160.

As set forth above, according to embodiments of the present invention, since back electromotive force is amplified with a gain in inverse proportion to a rotational speed of the motor, the amplified back electromotive force can be detected to fall within a predetermined range irrespective of the rotational speed of the motor, and thus, driving of the motor can be more accurately controlled.

While the present invention has been shown and described in connection with the embodiments, it will be apparent to those skilled in the art that modifications and variations can be made without departing from the spirit and scope of the invention as defined by the appended claims.

What is claimed is:

1. A back electromotive force detection circuit comprising:
a voltage generating unit generating a voltage in inverse proportion to a duty ratio of a pulse width modulation (PWM) signal;
a variable amplifier controlling a gain according to the voltage generated by the voltage generating unit, and amplifying back electromotive force according to the controlled gain; and
a comparator comparing an output from the variable amplifier with a pre-set reference signal, and outputting a zero-crossing signal of the back electromotive force.

2. The back electromotive force detection circuit of claim 1, wherein the voltage generating unit comprises:
a duty calculator calculating a duty ratio of the PWM signal; and
a DC voltage generator generating a DC voltage in inverse proportion to the duty ratio calculated by the duty calculator.

3. The back electromotive force detection circuit of claim 2, wherein the duty calculator further comprises:
a clock generator generating clocks having a frequency higher than that of the PWM signal; and
wherein the duty calculator calculates a duty ratio of the PWM signal by using an amount of the clocks in which the PWM signal has a high value during a predetermined period of time.

4. The back electromotive force detection circuit of claim 2, wherein the DC voltage generator comprises:
a plurality of resistors connected in series to an input voltage; and
a plurality of switches connected to one end of any one of the plurality of resistors in parallel.

5. The back electromotive force detection circuit of claim 4, wherein when the plurality of switches are switched on, the plurality of switches output different voltage values, and the duty calculator turns on any one of the plurality of switches to gain a voltage in inverse proportion to the duty ratio of the PWM signal.

6. A motor driving control apparatus comprising:
a driving signal generating unit generating a pulse width modulation (PWM) signal for controlling driving of a motor device;
a back electromotive force detection unit detecting a zero-crossing point of back electromotive force of the motor device, independently from a change in a rotational speed of the motor device; and
a controller determining a phase conversion time of the motor device according to the zero-crossing point, and controlling the driving signal generating unit to adjust the PWM signal.

7. The motor driving control apparatus of claim 6, wherein the rotational speed of the motor device is proportional to a duty ratio of the PWM signal, and
the back electromotive force detection unit amplifies the back electromotive force with a gain in inverse proportion to the duty ratio of the PWM signal, and detects the zero-crossing point by using back electromotive force having a predetermined range value independently from a change in the rotational speed of the motor device.

8. The motor driving control apparatus of claim 6, wherein the back electromotive force detection unit comprises:
a back electromotive force amplifying unit amplifying the back electromotive force with a gain in inverse proportion to the duty ratio of the PWM signal; and
a comparator comparing the back electromotive force amplified by the back electromotive force amplifying unit with a pre-set reference signal, and outputting a zero-crossing signal of the back electromotive force.

9. The motor driving control apparatus of claim 8, wherein the back electromotive force amplifying unit comprises:
a voltage generating unit generating a voltage in inverse proportion to the duty ratio of the PWM signal; and
a variable amplifier controlling a gain according to a voltage generated by the voltage generating unit and amplifying the back electromotive force according to the controlled gain.

10. The motor driving control apparatus of claim 9, wherein the voltage generating unit comprises:
a clock generator generating clocks having a frequency higher than that of the PWM signal;
a duty calculator calculating a duty ratio of the PWM signal by using an amount of the clocks in which the PWM signal has a high value during a predetermined period of time; and
a DC voltage generator generating a DC voltage in inverse proportion to the duty ratio calculated by the duty calculator.

11. The motor driving control apparatus of claim 10, wherein the DC voltage generator comprises:
a plurality of resistors connected in series to an input voltage; and
a plurality of switches connected to one end of any one of the plurality of resistors in parallel and outputting different voltage values in the event of ON switching,
wherein the duty calculator turns on any one of the plurality of switches to gain a voltage in inverse proportion to the duty ratio of the PWM signal.

12. A motor comprising:
a motor device rotating according to a pulse width modulation (PWM) signal; and
a motor driving control apparatus determining a phase conversion time of the motor device by detecting a zero-crossing point of back electromotive force of the motor device independently from a change in a rotational speed of the motor device, and controlling driving of the motor device by providing the PWM signal reflecting the phase conversion time to the motor device.

13. The motor of claim 12, wherein the motor driving control apparatus comprises:
a driving signal generating unit generating a PWM signal for controlling driving of the motor device;
a back electromotive force detection unit detecting a zero-crossing point of back electromotive force of the motor device, independently from a change in a rotational speed of the motor device; and
a controller determining a phase conversion time of the motor device according to the zero-crossing time, and controlling the driving signal generating unit to adjust the PWM signal.

14. The motor of claim 13, wherein the back electromotive force detection unit comprises:
a voltage generating unit generating a voltage in inverse proportion to a duty ratio of the PWM signal;
a variable amplifier controlling a gain according to the voltage generated by the voltage generating unit and amplifying back electromotive force according to the controlled gain; and
a comparator comparing an output from the variable amplifier with a pre-set reference signal and outputting a zero-crossing signal of the back electromotive force.

15. The motor of claim 14, wherein the voltage generating unit comprises:
a clock generator generating clocks having a frequency higher than that of the PWM signal;
a duty calculator calculating a duty ratio of the PWM signal by using an amount of the clocks in which the PWM signal has a high value during a predetermined period of time; and
a DC voltage generator generating a DC voltage in inverse proportion to the duty ratio calculated by the duty calculator.
